(19) United States
(12) Patent Application Publication
(10) Pub. No.: US 2004/0153328 A1
(43) Pub. Date: Aug. 5, 2004

(54) Guided card appendage

(76) Inventor: Pavel Macholda, West Linn, OR (US)

Correspondence Address: Pavel Macholda, Suite 200, 1800 Blankenship Road, West Linn, OR, 97068, US

(21) Appl. No.: 10/356,090

(22) Filed: Feb. 3, 2003

(51) Int. Cl. G06F 17/60

(52) U.S. Cl. 705/1; 715/517

(57) ABSTRACT

The Guided Card Appendage method allows the sender of an electronic mail message to attach a an electronic business card and to change the contents of the business card at any later time. Thus whenever the electronic mail recipient opens an archived electronic mail message, the contents of the attached business card always show the latest contact information of the sender.

### CROSS-REFERENCE TO RELATED APPLICATIONS

None

### STATEMENT REGARDING FED SPONSORED R&D

Neither the invention, nor any part of it, was made under federally sponsored research and development

### REFERENCE TO SEQUENCE LISTING

None

### BACKGROUND OF THE INVENTION

1. Field of the Invention

The invention relates to the field of applications for communication devices capable of storing and processing information in a digital form, such as cellular phones, wireless personal digital assistants, network appliances and computers. The closest U.S. patent Classification Definition is described in Class 707, Subclass 104—application of distributed data structure to commercial fields.

2. Background Information

Many people often send and receive electronic mail. They store the electronic mail messages in their computers or wireless devices, and often search or scroll through the folders, containing the messages, in order to find a piece of electronic mail that contains the contact information supplied by the sender. Even though the last piece of electronic mail may be weeks, months, or even years old, some people use the information contained in such a message to contact the sender. Often, the sender has meanwhile changed the e-mail address or the phone number that he or she originally supplied in the old electronic mail. Many people do not keep their address books up to date, or do not maintain address books at all, and rely solely on the electronic messages stored in their computers or wireless devices to find the contact information of a certain person.

### BRIEF SUMMARY OF THE INVENTION

The Guided Card Appendage method allows a person to change his or her contact, or other, information inside all the electronic mail messages that have been sent by the person (the sender) and are stored in various computers or wireless devices by the recipients. Thus, even if the sender changes, for instance, his or her e-mail address or phone number, and the recipient opens an old electronic mail in order to look up the contact information of the sender, the recipient always obtains the latest, current contact information of the sender.

Under the Guided Card Appendage system, the sender neither types in his or her contact information into the electronic mail message, nor attaches an electronic business card to the message, because such information would become an embedded part of the message and thus could not be easily changed. Rather, the sender includes a pointer information that specifies the location of the contact, or other, information in an independent device, outside the computer or wireless device of the recipient. Such an electronic business card, which may contain the sender's contact information, or any other information provided by the sender and which the sender may want to change occasionally, becomes a Guided Card, as the pointer information serves as a guide to the location of the actual information. There are two main advantages: first, the sender's information is not needlessly duplicated in each electronic message, but rather, the information resides in one place—thus, instead of losing control of the information at the moment when the user sends the message, the user retains control over his or her contact information inside the message; second, the sender can easily modify the information in the device where the information resides, because the sender has access to the device and thus to the information.

### DRAWINGS

### Brief Description of the Drawings

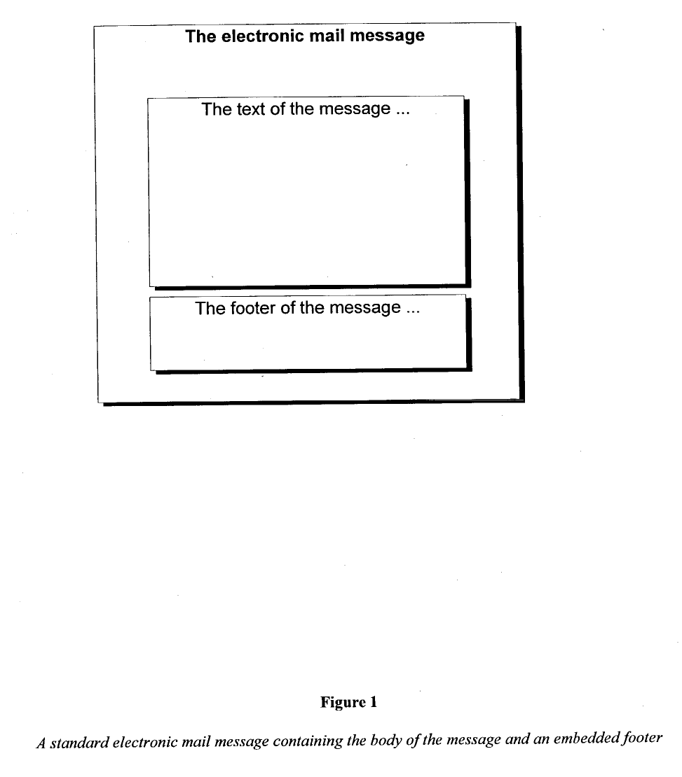

FIG. 1

In a standard electronic mail message, the footer information, if any exists, is embedded in the message and the entire message, including the footer, is transferred during the sending process from the device of the sender to the device of the recipient. The recipient may archive such a message in his or her device. Once the message is dispatched, the sender cannot change the information in the footer.

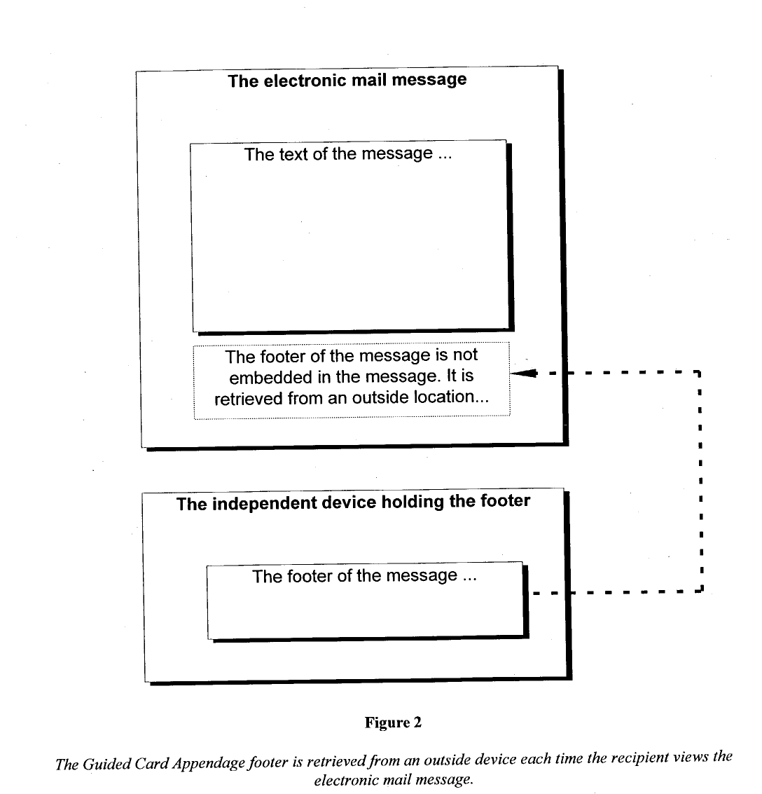

FIG. 2

The Guided Card Appendage is not embedded in the message, but rather the message contains the information regarding the location of the footer. When the recipient views the message, he or she perceive the footer as an integral part of the message, even though the footer is not embedded in the message, but rather is retrieved from an outside location each time the recipient opens the message.

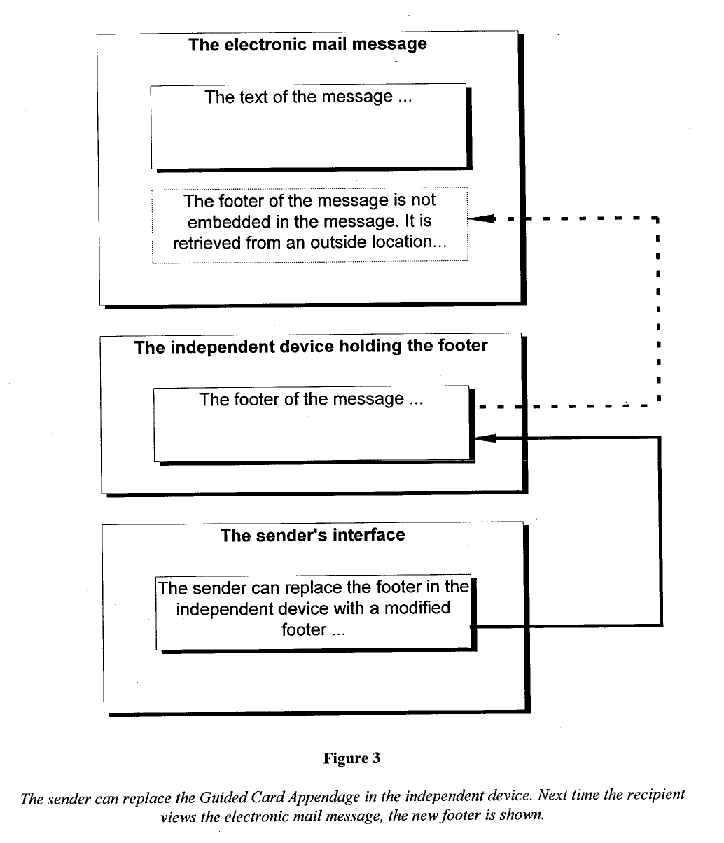

FIG. 3

The sender can access the Guided Card Appendage in the independent device that stores the footer and modify the contents. Next time, the recipient opens the message, the new footer is displayed in the mail message. If the footer contains the contact information of the sender, and the sender changed, for instance, his or her phone number in the card, the recipients sees the new phone number in the archived message.

### DETAILED DESCRIPTION

Most major electronic mail systems allow the sender to insert a piece of information at the end of the mail message. Most users utilize such a feature to include a standard end-of-letter greeting and their contact or company information. This information becomes a part of the mail message. Another feature of major electronic mail systems allows the user to attach files to an electronic mail message. When the systems display the message for the recipient to read, many systems automatically recognize if an attached file is a picture, and display the picture as a part of the message.

The Guided Card Appendage method provides the sender with a facility, such as an electronic device, computer software, or Internet facilitated service, that allows the sender to enter his or her contact, and other, information. The device stores the information and produces either a textual or graphic image which is identified by a pointer to its location. The sender can then attach the pointer to the electronic message. When the recipient reads the message, the electronic mail system encounters the pointer to the location and displays the contents found at the location specified by the pointer.

The image stored in the independent device and identified by the pointer contains the contact information of the sender, for instance, an image of a business card. Then, the recipient can see the business card, for instance, at the bottom of the electronic message. When the sender changes the contact information in the device, the device re-builds the business card image. When the recipient opens the electronic message again at a later date, the recipient sees the new business card within the archived electronic mail message. Thus, the recipients, who do not keep address books, but rather rely on archived electronic mail messages to retrieve the contact information of other people, can always obtain the latest, current contact information of the senders.

What is claimed is:

1. An electronic business card that can be attached to an electronic mail message and that changes its contents any time the sender updates his or her contact information in the device that stores the electronic business card.

2. An electronic business card that does not become an embedded part of an electronic mail message, but rather always resides in an independent device accessible for viewing by the recipient and for modification by the sender.

3. An electronic business card set forth in claims 1. and 2. that contains other information than contact information, as deemed desirable by the sender.

4. An electronic business card set forth in claims 1. and 2. that can be displayed as a part of the recipient's electronic mail message as a standard text or as a viewable graphic image.

5. An electronic business card set forth in claims 1. and 2. that can be kept in an electronic business card organizer together with cards produced by the same method.

6. An electronic business card set forth in claims 1. and 2. that can be indexed in an electronic business card organizer by the information contained in the card.

7. An electronic business card set forth in claims 1. and 2. that can distinguish between public and private information, as indicated by the owner of the card (the sender), and that can selectively display the private information based on who the viewer (the recipient) of the card is.
